(19) United States
(12) Patent Application Publication
(10) Pub. No.: US 2007/0147827 A1
(43) Pub. Date: Jun. 28, 2007

(54) Methods and apparatus for wireless stereo video streaming

(76) Inventors: Arnold Sheynman, Northbrook, IL (US); Juana E. Nakfour, Hawthorn Woods, IL (US); John C. Neumann, Chicago, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/321,122

(22) Filed: Dec. 28, 2005

(51) Int. Cl. G03B 35/00

(52) U.S. Cl. 396/325

(57) ABSTRACT

A wireless camera (102) is configured to removeably connect to a complementary camera (101) and includes machine-readable software instructions configured to communicate with the complementary camera to determine a designated role (e.g., “master” or “slave”). The software instructions are capable of performing, when the designated role is “master,” the steps of: capturing a first video frame; instructing the complementary camera (101) to capture a second video frame; receiving the second video frame from the complementary camera (101); combining the first frame and the second frame to create a combined frame associated with a stereoscopic image, and wirelessly transmitting the combined frame to a mobile device (140). When the designated role is “slave,” the wireless camera (102) is capable of performing the steps of: capturing a first video frame and sending the first video frame to the complementary camera (101).

### TECHNICAL FIELD

The present invention relates generally to video streaming and, more particularly, to systems and methods for wireless stereo video streaming in the context of mobile devices.

### BACKGROUND

Mobile devices such as cellular phones, personal data assistants (PDAs), and the like have achieved wide popularity in recent years. This popularity is due in part to the gradual increase in features incorporated into such devices. It is not uncommon, for example, for a mobile cellular phone to aggregate functionality once reserved for digital cameras, MP3 players, and other audio and video devices.

Many mobile device users—particularly young users—are interested in employing mobile devices to capture candid or spur-of-the-moment images and then displaying the images directly on the mobile device (or transmitting them over a phone-to-phone network) so that the images can be shared contemporaneously with friends.

Stereoscopic (or “3-D”) imaging is a highly-entertaining form of photography used for many years in the motion picture industry, and which is enjoying increased popularity as a result of advances in imaging technology. While cameras have been developed for capturing stereoscopic images, such systems tend to be bulky and expensive. That is, because prior art devices require that the expensive camera elements be physically attached or integrated into the mobile device, additional printed circuit board space and enclosure volume is required.

Furthermore, while it is possible to incorporate two cameras into a cellular phone or other mobile device to create a stereoscopic image, such a system may be undesirable in that users who do not intend to use the 3-D feature may be hesitant to purchase the device.

Accordingly, it is desirable to provide systems and methods for acquiring and displaying stereoscopic images on mobile devices in a cost-efficient and flexible manner. Other desirable features and characteristics of the present invention will become apparent from the subsequent detailed description of the invention and the appended claims, taken in conjunction with the accompanying drawings and this background of the disclosure.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic overview of a video streaming system in accordance with one embodiment;

FIG. 2 is a schematic overview of a video streaming system in accordance with another embodiment;

FIG. 3 is a schematic block diagram of a camera in accordance with one embodiment;

FIG. 4 is a flow-chart depicting an exemplary video streaming method in accordance with the present invention; and

FIGS. 5A and 5B are block diagram depicting, schematically, a set of exemplary connectors for use with a wireless camera.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to digital image acquisition, digital image processing, digital image compression, signal processing, various known standards and specifications (e.g., the Bluetooth set of standards), data transmission, signaling, network control, analog and digital telephony, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

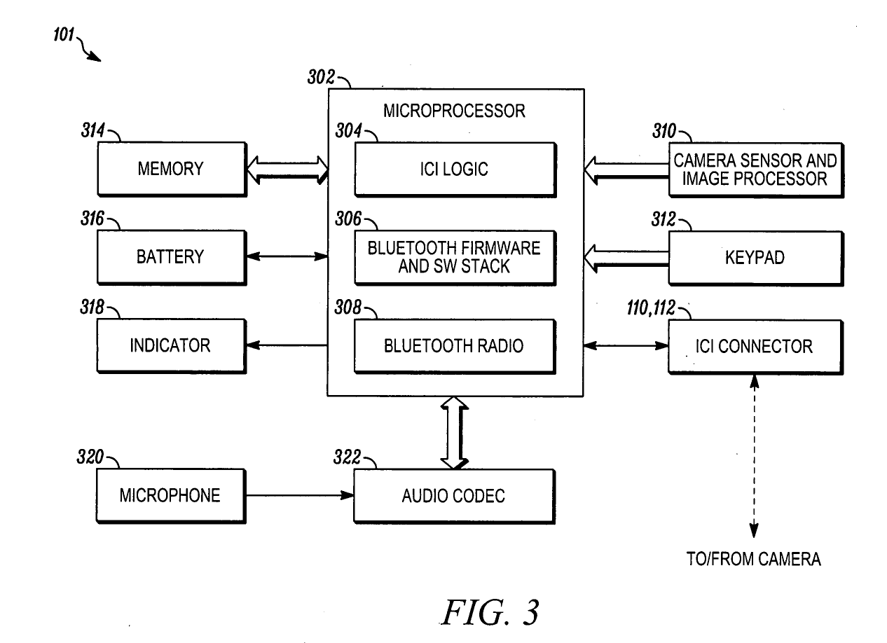

With respect to the terms “coupled” and “connected” as used herein, unless expressly stated otherwise, “connected” means that one node/feature is directly joined to (or directly communicates with) another node/feature, and not necessarily mechanically. Likewise, unless expressly stated otherwise, “coupled” means that one node/feature is directly or indirectly joined to (or directly or indirectly communicates with) another node/feature, and not necessarily mechanically. That is, the term “coupling” as used herein with respect to cameras and or other components means the association of two or more circuits or systems in such a way that power or signal information may be transferred from one to another. See, e.g., NEW IEEE STANDARD DICTIONARY OF ELECTRICAL AND ELECTRONICS TERMS (5th edition, 1993). Thus, for example, although the schematic shown in FIG. 3 depicts one example arrangement of components, additional intervening elements, devices, features, or components may be present in an actual embodiment.

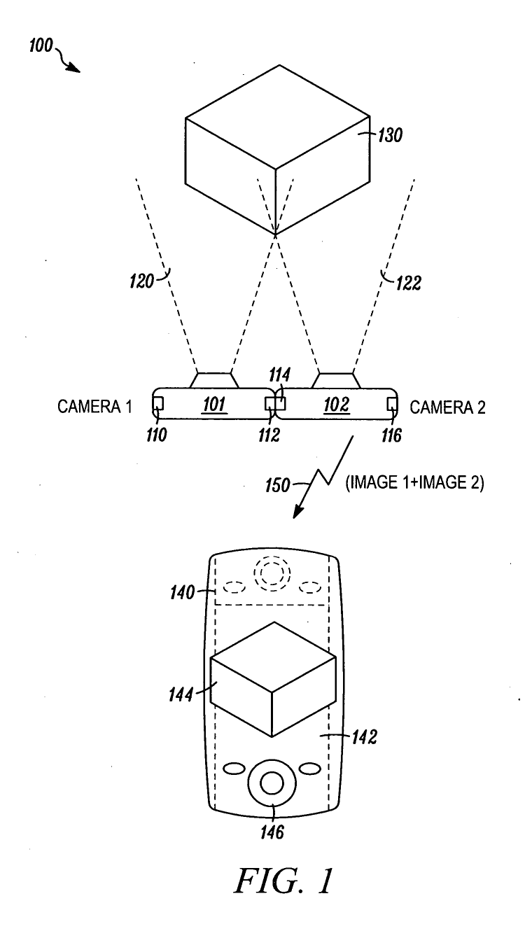

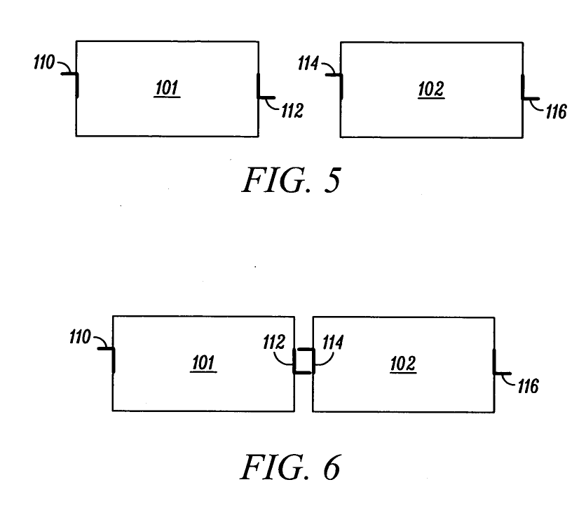

Referring to FIG. 1, a stereo video streaming system in accordance with one embodiment generally includes a mobile device 140, a first camera 102, and a second or “complementary” camera 101. Each camera 101 and 102 has corresponding fields of view 120 and 122, respectively, wherein an object 130 or other scene falls within fields of view 120 and 122. Cameras 101 and 102 are each capable of capturing an image of object 130. In this regard, for the purpose of clarity, an image (e.g., an image comprising a single video frame) captured by camera 102 is referred to as the “first image,” and an image captured by camera 101 is referred to as the “second image.” Each camera 101 and 102 also has at least one connector 110, 112, 114, and 116, which will be described in detail in conjunction with FIGS. 5 and 6.

Mobile device 140 refers to any device, such as a mobile phone, PDA, or the like, that includes a display 142 and a user interface 146. Mobile device 140 is configured to display a stereoscopic image 144 derived from a combined image transmitted via a link 150 from camera 102. In this regard, display 142 may include any system capable of communicating a 3-dimensional image to a human, alone or in combination with various viewing aids. In one embodiment, display 142 is an autostereoscopic display—i.e., a display that presents each eye a different image of a “stereo-pair” of images without the use of special glasses or intervening equipment.

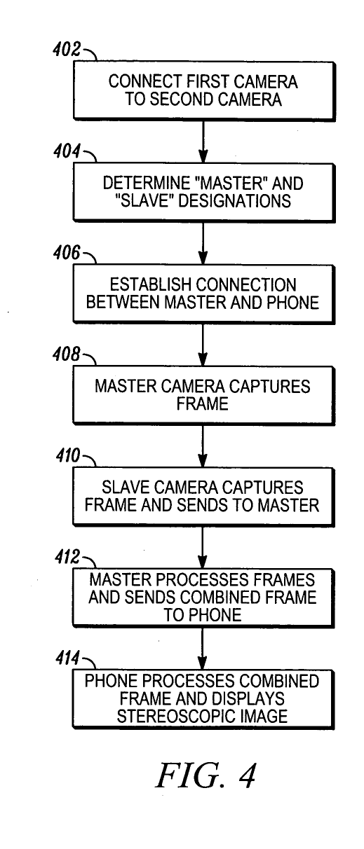

Referring to the flow-chart of FIG. 4 in conjunction with the system overview of FIG. 1, an exemplary stereo video streaming method will now be described. In this regard, it should be understood that the various tasks performed in connection with the method of FIG. 4 may be performed by software, hardware, firmware, or any combination thereof. For illustrative purposes, the following exemplary method may refer to elements mentioned above in connection with FIGS. 1-3. In various embodiments, portions of the method may be performed by different elements of the described system. It should also be appreciated that the method of FIG. 4 may include any number of additional, intervening, or alternative tasks, and need not be performed in the illustrated order.

First, camera 101 is connected to camera 102 in a manner that allows subsequent disconnection (step 402). That is, camera 101 is removeably attached to camera 102. The nature of this connection is discussed in further detail below.

After connection and suitable handshaking between the two cameras 101 and 102, a determination 404 is made as to which of the cameras should act as the “master,” and which should act as the “slave.” For the purpose of clarity, it should be noted that, while one embodiment is discussed in the context of Bluetooth communication, these “master/slave” designations are not intended to be used as those terms are precisely defined in the applicable Bluetooth standards.

The “master/slave” determination may be made in a number of ways and in accordance with a variety of criteria. In one embodiment, for example, the two cameras communicate and determine which has the greatest remaining battery power, and that camera is designated as master. In the event that the two cameras have substantially the same battery power, then selection may be determined randomly or in accordance with any other criterion.

After the master/slave designations 404 are determined, a wireless connection 150 is established between the master camera (camera 102 as illustrated in FIG. 1) and mobile device 140. Connection 150 may be, for example, a Bluetooth connection or a connection in accordance with any other communication protocol now known or later developed.

Master camera 102 captures an image corresponding to field of view 122 (step 408). At approximately the same time, slave camera 101 captures an image corresponding to field of view 120 (step 410) and sends that image (via connections 112, 114) to master camera 102. In one embodiment, slave camera 101 captures an image in response to a request from master camera 102.

Next, master camera 102 processes the first image and the second image to produce a combined image or frame, which it then sends via link 150 to mobile device 140 (step 412). Cameras 101 and 102 are suitably configured, physically, such that the two images corresponding to fields of view 120 and 122, as combined by master phone 102, correspond to a stereoscopic image. More particularly, cameras 101 and 102 are positioned to provide an effective “parallax” such that the images may be combined to retain depth information. Combination of the first image and the second image may involve, for example, simply concatenating the second video image data to the first video image data. In another embodiment, the first frame is altered using data associated with the second frame. Example methods of altering frames in this way may be found, for example, in Siegel et al., Compression of Stereo Image Pairs and Streams, Stereoscopic Displays and Virtual Reality Systems, Vol. 2177, 258-68 (1994). Alternately, on image may be rotated during the step of combining. For example, if one camera is upside down relative to the other camera when the cameras are connected, the step of combining would include rotating one of the images 180°.

Finally, mobile device 140 processes the received combined image and displays a stereoscopic image 144 on display 142. In this regard, a variety of algorithms exist for creating stereoscopic images. See, e.g., Zabih et al., Non-parametric Local Transforms for Computing Visual Correspondence, 3d European Conference on Computer Vision, 151-58 (1994). In the event that mobile device 140 is operating in a video mode (rather than a still image mode), the process loops back to step 408, and successive images are displayed in accordance with a refresh rate.

In one embodiment, each camera 101 and 102 operates differently depending upon whether it is designated as the “master” or “slave” camera. Stated another way, a given wireless camera 102 is configured to removeably connect to a complementary camera 101, wherein camera 102 is configured to communicate with complementary camera 101 to determine a designated “master/slave” role. When the designated role of camera 102 is “master,” it captures a first video frame, instructs complementary camera 101 to capture a second video frame; receives the second video frame from complementary camera 101; combines the first frame and the second frame to create a combined frame associated with a stereoscopic image (e.g., of an object 130), then wirelessly transmits the combined frame to mobile device 140 via communication link 150. In the event that the designated role of camera 102 is “slave,” it captures a first video frame (e.g., in response to a request from the master camera), then sends the first video frame to the master camera.

In one embodiment, the master camera is configured to send a clock signal to the slave camera. This assists in synchronization of image acquisition and other functions. In another embodiment of the invention, the master camera is configured to communicate with the slave camera to determine which of the two cameras is the “right” camera, and which is the “left” camera of a stereoscopic pair. This may be accomplished in a variety of ways. For example, in one embodiment, tags are assigned to the camera connectors (e.g., “left” and “right” tags). When the cameras are connected together, the master camera identifies which connector is occupied—“left” or “right”—and makes the determination accordingly. In accordance with another embodiment, an accelerometer or other relative or absolute position sensor is used.

In another embodiment, the combined image sent from camera 102 is compressed prior to transmission and then decompressed by mobile device 140 prior to display. Any suitable compression algorithm may be used, including various MPEG formats such as MPEG2, MPEG4, and the like.

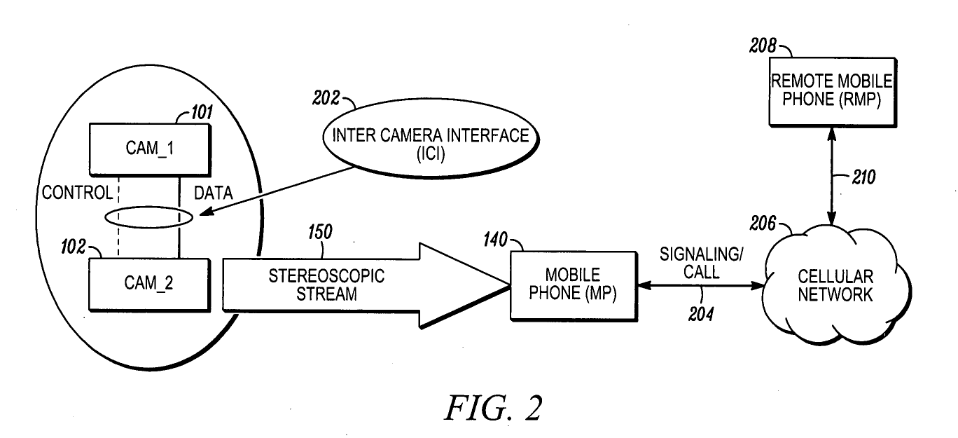

As it is desirable to allow sharing of images between mobile phones and the like, a video streaming system in accordance with one embodiment allows transmission of video to a remote mobile phone. Such an embodiment is shown in FIG. 2, wherein cameras 101 and 102—which communicate via inter-camera interface 202 and send the resultant stereoscopic stream 150 to a mobile device 140—is further configured to communicate over a cellular network 206. That is, in accordance with conventional signaling methods, mobile device 140 establishes a connection 204 over a cellular network 206 and connection 210 to a remote mobile phone (RMP) 208. The stereoscopic stream 150 can then be transmitted to, and viewed by, RMP 208.

Referring to FIG. 3, an exemplary camera 101 in accordance with one embodiment includes a microprocessor 302, a memory 314, a camera module 310, a keypad (or other I/O component) 312, an audio codec 322, a microphone 320, an indicator 318, a battery 316, and one or more connectors 110 and 112. Microprocessor includes and/or is configured to carry out instructions associated with ICI logic 304, firmware 306, and radio 308.

The camera module 310 includes any suitable combination of hardware and software configured to acquire a digital image, process that image, and transfer the image to the microprocessor 302. In this regard, the camera module 310 may include various CCD imaging components, signal processors, lenses and the like. The resolution, bit-depth, and refresh of the acquired image may be selected in accordance with desired speed, quality, etc. Camera module 310 may implement any of the various image processing techniques traditionally used in connection with still or video imaging.

Keypad 312 includes one or more I/O components—for example, one or more keys, buttons, switches, pointing devices, touch-pads, and the like. In one embodiment, keypad 312 includes I/O components configured to allow the user to control imaging (e.g., on/off, exposure settings, shutter release, etc.) as well as operation of camera 101 as described below.

Audio codec 322 includes suitable software and/or hardware components capable of providing encoding and decoding of audio received via a microphone 320 provided within (and/or external to) camera 101. Such codecs and microphones are well known in the art, and thus need not be discussed further herein. Including an audio codec 322 and a microphone 320 in camera 101 allows for the reception and transmission of stereo audio to the mobile device 140. Battery 316 includes one or more power sources, either disposable or rechargeable, capable of providing power to the various components present within camera 101.

Microprocessor 302 is any suitable semiconductor device capable of carrying out, either alone or in combination with the other illustrated components (e.g., a volatile or non-volatile memory 314), the functions described herein, including those associated with ICI logic 304, firmware 306, and radio 308. In one embodiment, firmware 306 comprises Bluetooth firmware, and radio 308 is a radio operating in accordance with applicable Bluetooth standards. For more information regarding the Bluetooth communication protocol, see, e.g., Bluetooth SIG core specification v2.0 et seq. ICI logic block 304 includes machine-readable instructions capable of carrying out the camera interoperability functions described above in connection with FIG. 4.

Connector or connectors 110 and 112 allow one camera to be removeably attached to another camera such that stereo images can be produced. Any type and number of connectors may be used; however, in one embodiment, each camera includes connectors that are “symmetrical.” As used herein with respect to connectors, the term “symmetrical” means that each connector allows connection with another camera having the same connector, but only in an orientation having a particular rotational symmetry with respect to the first camera.

More specifically, referring to the schematic diagrams shown in FIGS. 5 and 6, a camera 101 has connectors 110 and 112, and camera 102 includes similarly-configured connectors 114 and 116. For the purpose of this example, it is assumed that cameras 101 and 102 are being viewed from behind (i.e., opposite the imaging direction). The “L” and inverted-“L” shapes shown in FIGS. 5 and 6 are merely abstract representations of the connectors, and are not intended as geometrical limitations.

As shown in FIG. 6, camera 101 may be removeably connected to camera 102 in that connector 112 and connector 114 fit together in one orientation. If camera 102 were to be rotated 180° along the horizontal axis, or if it were to be rotated 180° along the vertical axis, then camera 101 would not connect to camera 102. Connectors 110 and 112 are symmetrical with respect to camera 101 in the sense that, with respect to some point on the camera (e.g., the center of an imaging component), connectors 110 and 112 exhibit two-fold rotational symmetry.

In summary, various video streaming systems and methods have been presented. In accordance with one embodiment, a method is provided for streaming stereo video to a mobile device from a first camera and a second camera, the method comprising: removeably attaching the first camera to the second camera; capturing, via the first camera, a first video frame; capturing, via the second camera, a second video frame; sending the second video frame to the first camera; combining the first frame and the second frame to create a combined frame; wirelessly transmitting the combined frame from the first camera to the mobile device; displaying, on the mobile device, a stereoscopic image derived from the combined frame. In one embodiment, the cameras are removeably attached by connecting the first camera to the second camera via an interface connector provided on both the first and second cameras.

A further embodiment involves determining “master” and “slave” designations for the first and second cameras. This may be accomplished, for example by: measuring a first battery level of the first camera; measuring a second battery level of the second camera; designating the first camera as “master” if the first battery level is greater than the second battery level, and designating the second camera as “master” if the second battery level is greater than the first battery level. A further embodiment includes providing a clock-signal to the camera designated as “slave” via the camera designated as “master.” One embodiment further includes requesting, via the camera designated as “master,” that the camera designated as “slave” acquire the second frame. Another embodiment includes determining “left” and “right” designations for the first and second cameras.

In accordance with another embodiment, the method further involves compressing, at the second camera—and decompressing, at the mobile device—the combined frame. In one embodiment, the combining step comprises concatenating the second video frame to the first video frame. In another, this combination involves altering the first frame using data from the second frame. Yet another embodiment includes transmitting stereo audio from the first and second cameras to the mobile device.

A system for streaming stereo video in accordance with one embodiment of the invention comprises: a first camera configured to capture a first image; a second camera connected to the first camera, the second camera configured to capture a second image and send the second image to the first camera; the first camera configured to combine the first image and the second image to create a combined image, and to wirelessly transmit the combined image to a mobile device; the mobile device configured to display a stereoscopic image derived from the combined image. In one embodiment, the system further comprises an interface connector configured to removeably attach the first camera and the second camera.

A wireless camera in accordance with one embodiment is configured to removeably connect to a complementary camera, the wireless camera including machine-readable software instructions configured to perform the steps of: communicating with the complementary camera to determine a designated role, wherein the designated role is selected from the group consisting of “master” and “slave”; performing, when the designated role is “master,” the steps of: capturing a first video frame; instructing the complementary camera to capture a second video frame; receiving the second video frame from the complementary camera; combining the first frame and the second frame to create a combined frame associated with a stereoscopic image, wirelessly transmitting the combined frame to a mobile device; and performing, when the designated role is “slave,” the steps of: capturing a first video frame; sending the first video frame to the second camera.

In accordance with a further embodiment, the camera further performs compressing, at the wireless camera, the combined frame, and decompressing, at the mobile device, the combined frame.

In one embodiment, the machine-readable software instructions are further configured to perform, when the designated role is “master,” providing a clock signal to the complementary camera.

In another embodiment, the machine-readable software instructions are further configured to determine the designated role based on a first battery level of the wireless camera and a second battery level of the complementary camera.

In yet another embodiment, the machine-readable software instructions are further configured to communicate with the complementary camera to determine whether the wireless camera is a “left” or “right” of a stereoscopic pair. In one embodiment, the camera further including a Bluetooth radio. In another, the camera further includes a pair of symmetrical interface connectors configured to facilitate removable connection to the complementary camera.

While at least one example embodiment has been presented, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for streaming stereo video to a mobile device from a first camera and a second camera, the method comprising:
removeably attaching the first camera to the second camera;
capturing, via the first camera, a first video frame;
capturing, via the second camera, a second video frame;
sending the second video frame to the first camera;
combining the first frame and the second frame to create a combined frame;
wirelessly transmitting the combined frame from the first camera to the mobile device;
displaying, on the mobile device, a stereoscopic image derived from the combined frame.

2. The method of claim 1, wherein the removeably attaching includes connecting the first camera to the second camera via an interface connector provided on both the first camera and the second camera.

3. The method of claim 1, further including:
determining “master” and “slave” designations for the first camera and the second camera.

4. The method of claim 3, wherein the determining includes:
measuring a first battery level of the first camera;
measuring a second battery level of the second camera;
designating the first camera as “master” if the first battery level is greater than the second battery level, and designating the second camera as “master” if the second battery level is greater than the first battery level.

5. The method of claim 3, further including: providing a clock-signal to the camera designated as “slave” via the camera designated as “master.”

6. The method of claim 3, further including: requesting, via the camera designated as “master,” that the camera designated as “slave” acquire the second video frame.

7. The method of claim 1, further including:
determining “left” and “right” designations for the first camera and the second camera.

8. The method of claim 1, further including:
compressing, at the second camera, the combined frame;
decompressing, at the mobile device, the combined frame.

9. The method of claim 1, wherein the combining comprises concatenating the second video frame to the first video frame.

10. The method of claim 1, wherein the combining comprises altering the first video frame using data from the second frame.

11. The method of claim 1, further including transmitting stereo audio from the first camera and the second camera to the mobile device.

12. A system for streaming stereo video comprising:
a first camera configured to capture a first image;
a second camera connected to the first camera, the second camera configured to capture a second image and send the second image to the first camera;
the first camera configured to combine the first image and the second image to create a combined image, and to wirelessly transmit the combined image to a mobile device;
the mobile device configured to display a stereoscopic image derived from the combined image.

13. The system of claim 12, further comprising an interface connector configured to removeably attach the first camera and the second camera.

14. The system of claim 12, wherein the first camera and the second camera are configured to respectively send the first image and the image directly to the mobile device, and wherein the mobile device is configured to combine the first image and the second image to create the combined image.

15. A wireless camera configured to removeably connect to a complementary camera, the wireless camera including machine-readable software instructions configured to perform the steps of:
communicating with the complementary camera to determine a designated role, wherein the designated role is selected from the group consisting of “master” and “slave”;
performing, when the designated role is “master,” the steps of:
capturing a first frame;
instructing the complementary camera to capture a second frame;
receiving the second frame from the complementary camera;
combining the first frame and the second frame to create a combined frame associated with a stereoscopic image,
wirelessly transmitting the combined frame to a mobile device;
performing, when the designated role is “slave,” the steps of:
capturing a first frame;
sending the first frame to the complementary camera.

16. The method of claim 15, further including:
compressing, at the wireless camera, and decompressing, at the mobile device, the combined frame.

17. The wireless camera of claim 15, wherein the machine-readable software instructions are further configured to perform, when the designated role is “master,” providing a clock signal to the complementary camera.

18. The wireless camera of claim 15, wherein the machine-readable software instructions are further configured to determine the designated role based on a first battery level of the wireless camera and a second battery level of the complementary camera.

19. The wireless camera of claim 15, wherein the machine-readable software instructions further configured to communicate with the complementary camera to determine whether the wireless camera is a “left” or “right” of a stereoscopic pair.

20. The wireless camera of claim 15, further including a pair of symmetrical interface connectors configured to facilitate removable connection to the complementary camera.
